(19) United States
(12) Patent Application Publication
(10) Pub. No.: US 2020/0366518 A1
(43) Pub. Date: Nov. 19, 2020

(54) INFRARED VOICE-CONTROLLED SYSTEM AND INFRARED VOICE-CONTROLLED DEVICE

(71) Applicant: MING-TSUNG CHEN, Taipei City (TW)

(72) Inventor: MING-TSUNG CHEN, Taipei City (TW)

(21) Appl. No.: 16/559,714

(22) Filed: Sep. 4, 2019

Related U.S. Application Data
(60) Provisional application No. 62/846,975, filed on May 13, 2019.

(51) Int. Cl. H04L 12/28; G05B 19/04

(52) U.S. Cl. CPC H04L 12/2829; H04L 12/2832; G05B 2219/25192; G05B 19/041; H04L 12/282

(57) ABSTRACT

An infrared voice-controlled system includes an infrared voice-controlled device, a service server, and an infrared signal database. The infrared voice-controlled device is connected to a first electronic device. The infrared voice-controlled device is connected to the service server. The service server is connected to the infrared signal database. When the infrared voice-controlled device receives an audio control signal corresponding to the first electronic device, the infrared voice-controlled device transmits the audio control signal to the service server. The service server transmits a device control signal corresponding to the audio control signal and the first electronic device to the infrared voice-controlled device. The infrared voice-controlled device controls the first electronic device based on the device control signal. The device control signal includes a first infrared communication protocol. The first infrared communication protocol is stored in the infrared signal database.

### CROSS-REFERENCE TO RELATED PATENT APPLICATION

This application claims priority from the U.S. Provisional Patent Application Ser. No. 62/846,975 filed May 13, 2019, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a voice-controlled system and a voice-controlled device, and more particularly to a voice-controlled system and a voice-controlled device with infrared remote control function.

### BACKGROUND OF THE DISCLOSURE

In general, a voice-controlled device, a cloud server and a gateway device are used to transmit control signals to control home appliances by the network connection. However, many home appliances are still remotely controlled by infrared control signals, and such home appliances cannot be included in the network of smart homes.

Therefore, it is an important subject in the art to provide a voice-controlled system and a voice-controlled device with infrared remote control function.

### SUMMARY OF THE DISCLOSURE

In response to the above-referenced technical inadequacies, the present disclosure provides an infrared voice-controlled system. The infrared voice-controlled system includes an infrared voice-controlled device, a service server, and an infrared signal database. The infrared voice-controlled device connected to a first electronic device. The infrared voice-controlled device is connected to the service server. The service server is connected to the infrared signal database. When the infrared voice-controlled device receives an audio control signal corresponding to the first electronic device. The infrared voice-controlled device transmits the audio control signal to the service server. The service server transmits a device control signal corresponding to the audio control signal and the first electronic device to the infrared voice-controlled device. The infrared voice-controlled device controls the first electronic device based on the device control signal. The device control signal includes a first infrared communication protocol. The first infrared communication protocol is stored in the infrared signal database.

In one aspect, the present disclosure provides an infrared voice-controlled device. The infrared voice-controlled device includes a processing module, a microphone module, an infrared signal transmitting module, and infrared signal receiving module, a first communication module, and a second communication module. The microphone module receives an audio control signal. The infrared signal transmitting module transmits an infrared control signal. The infrared signal receiving module receives an infrared control signal. The first communication module is used for being connected to a server. The processing module electrically is connected to the microphone module, the infrared signal receiving module, the infrared signal transmitting module, the first communication module, and the second communication module. When microphone module of the infrared voice-controlled device receives an audio control signal corresponding to the first electronic device, the processing module transmits the audio control signal to the service server. The service server transmits a device control signal corresponding to the audio control signal and the first electronic device to the infrared voice-controlled device. The infrared voice-controlled device controls the first electronic device based on the device control signal. The infrared signal transmitting module transmits a first infrared control signal to control the first electronic based on the device control signal.

Therefore, the infrared voice-controlled system and the infrared voice-controlled device directly utilize the infrared signal transmitting module of the infrared voice-controlled device to control the electronic device. It is not necessary to use another control device to transmit control signals, so as to reduce equipment costs.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram of an infrared voice-controlled system according to an embodiment of the present disclosure.

FIG. 2 is a schematic diagram of an infrared voice-controlled device in FIG. 1.

FIG. 3 is a schematic diagram showing the infrared voice-controlled system being configured in a predetermined area.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

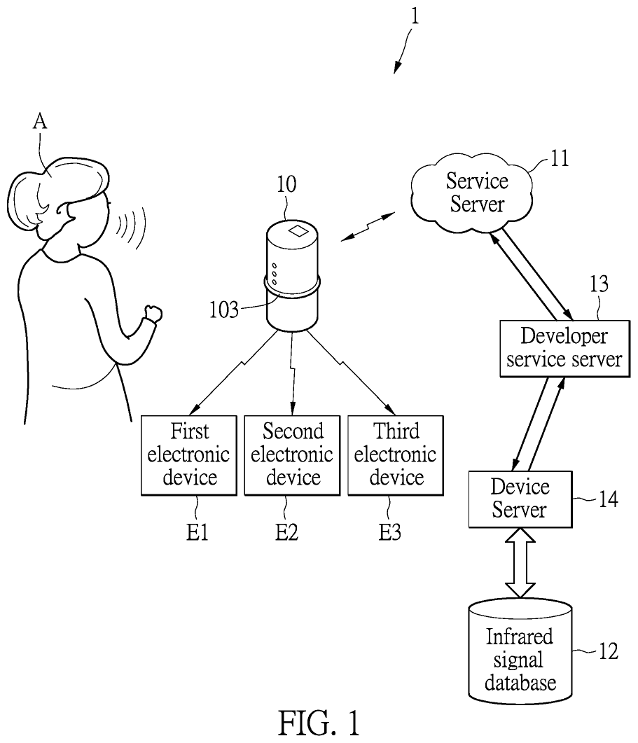

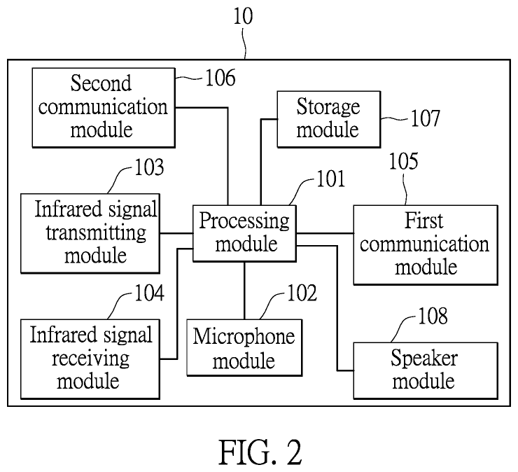

Referring to FIG. 1 and FIG. 2, FIG. 1 is a schematic diagram of an infrared voice-controlled system according to an embodiment of the present disclosure. FIG. 2 is a schematic diagram of an infrared voice-controlled device in FIG. 1.

An infrared voice-controlled system 1 includes an infrared voice-controlled device 10, a service server 11, n developer service server 13, a device server 14, and an infrared signal database 12.

The infrared voice-controlled device 10 is connected to the service server 11, and the service server 11 is connected to the developer service server 13. The developer service server 13 is connected to the device server 14. The device server 14 is connected to the infrared signal database 12. In the embodiment, the service server 11, the developer service server 13, and the device server 14 are respectively configured in different remote servers. In other embodiments, the service server 11, the developer service server 13, the device server 14 can be configured in the same server, but is not limited in the present disclosure. In other words, the service server 11 can transmit a service turn-on signal to the developer service server 13 and the device server 14 for performing searches, analyses, or updates in the infrared signal database 12.

In other words, the infrared voice-controlled device 10 transmits an audio control signal to the service server 11. The service server transmits a service turn-on signal to the developer service server 13 based on a service control signal analyzed by the service server 11. Then, the developer service server 13 transmits a device service turn-on signal to the device server 14 based on the service turn-on signal. The device server 14 obtains a type of the electronic device based on the device service turn-on signal, and searches the corresponding infrared communication protocol in the infrared signal database 12. The infrared signal database 12 includes a plurality of infrared communication protocols.

In the embodiment, the infrared voice-controlled device 10 includes a processing module 101, a microphone module 102, an infrared signal transmitting module 113, and an infrared signal receiving module 114, a first communication device 115, a second communication module 116, a storage module 117, and a speaker module 118.

The processing module 101 is electrically connected to the microphone 102, the infrared signal transmitting module 103, the infrared signal receiving module 104, the first communication module 105, the second communication module 106, the storage module 107, and the speaker module 108. The microphone module 102 is configured for receiving an audio control signal. The infrared signal receiving module 104 is configured for receiving an infrared control signal. The infrared signal transmitting module 103 is configured for transmitting the infrared control signal.

In the embodiment, the infrared voice-controlled device 10 is connected to a first electronic device E1, a second electronic device E2, and a third electronic device E3. The first electronic device E1, the second electronic device E2, and the third electronic device E3 are the electronic devices controlled by infrared control signals, such as air conditioner, fans, televisions, set-top boxes or CD players.

When the user A transmits an audio control signal, such as that of the voice command “Hello, adjust the temperature of the air conditioner to 24 degrees”, the microphone module 102 of the infrared voice-controlled device 10 receives the audio control signal, and the processing module 101 transmits the audio control signal to the service server 11. The service server 11 processes a semantic analysis of the audio control signal, and the service server 11 extracts certain features, such as “air conditioner”, “24 degrees”. In this instance, the service server 11 transmits a service turn-on signal to the corresponding developer service server 13 based on the feature “air conditioner” of the audio control signal. In the embodiment, the developer service server 13 is a service server built by a developer of one electronic device. In other embodiments, the developer service server 13 is configured in the service server 11, and supplies a serverless computing service to a plurality of developers. When the developer service server 13 receives the service turn-on signal, the developer service server 13 transmits a device service turn-on signal to the device server 14 based on the service turn-on signal corresponding to the feature “air conditioner” of the audio control signal. Therefore, the device server 14 transmits a first infrared communication protocol corresponding to the feature “air conditioner” of the audio control signal.

When the device searches the first infrared communication protocol in the infrared signal database 12 based on the device service turn-on signal, the device server 14 transmits the first infrared communication protocol to the service server 11. Then, the service server 11 transmits the first infrared communication protocol and a device control signal to the infrared voice-controlled 10. The infrared voice-controlled 10 transmits an infrared control signal to adjust the temperature of the air conditioner to the 24 degrees based on the first infrared communication protocol and the device control signal.

When the device does not search the first infrared communication protocol in the infrared signal database 12 based on the device service turn-on signal, the device server 14 transmits a suggestion signal to the developer service server 13, the service server 11 and the infrared voice-controlled device 10 for suggesting the user to record the infrared control signal of the air conditioner. Therefore, the infrared voice-controlled device 10 can fully assist the user for reducing the procedures and steps for controlling home appliances. In the embodiment, the infrared voice-controlled device 10 utilizes the speaker module 118 and an artificial intelligence system to make suggestions and responses to the user A in a spoken voice.

Regarding the recording of the infrared remote signal, the user can use an unrecorded infrared remote device to align to the infrared signal receiving module 104 of the infrared voice-controlled device 10 and transmit signals. The infrared voice-controlled device 10 can record the infrared remote signals of the unrecorded infrared remote device to be stored in the storage module 117. Then, the infrared voice-controlled device 10 transmits the unrecorded infrared remote signals to the infrared signal database 12 for updating the infrared signal database 12 through the service server 11, the developer service server 13 and the device server 14. Therefore, the user can directly transmit an audio control signal to the infrared voice-controlled device 10 for controlling the home appliances that have recorded the infrared control signals.

In other embodiments, the service server 11, the developer service server 13 and the device server 14 can be configured in the same server. In other words, when the infrared voice-controlled device 10 transmits the audio control signal to the service server 11, the service server 11 processes the semantic analysis of the audio control signal and converts the audio control signal to the device control signal. Therefore, the service server 11 transmits the device control signals and the corresponding infrared communication protocol to the infrared voice-controlled device 10. The infrared voice-controlled device 10 can transmit the infrared control signal to the first electronic device E1, the second electronic device E2, and the third electronic device E3, and the infrared control signal is determined based on the device control signal and the corresponding infrared communication protocol.

In addition, the infrared signal transmitting module 103 is arranged at the exterior of the infrared voice-controlled device 10 in a ring-shaped manner. The infrared signal receiving module 104 can be arranged at a predetermined position, or similarly arranged at the exterior of the infrared voice-controlled device 10 in a ring-shaped manner, but is not limited in the present disclosure.

In addition, the user A can pre-record the infrared control signal of the first electronic device E1, the second electronic device E2, and the third electronic device E3 in the infrared signal database 12 by the infrared signal receiving module 104 of the infrared voice-controlled device 10. The device control signal includes a first infrared communication protocol, and the first infrared communication protocol is stored in the infrared signal database 12.

The infrared voice-controlled device 10 communicates with the service server 11 by the first communication module 115. The infrared voice-controlled device 10 communicates with another infrared voice-controlled device by the second communication module 116. In the embodiment, the first communication module 116 is a Wi-Fi communication module, a Bluetooth™ communication module, a Zigbee communication module, a LoRa communication module, a Sigfox communication, or a NB-IoT communication module. The second communication module 116 is a Bluetooth™ 5.0 or a Bluetooth™ 5.1 communication module. In other words, the second communication is a communication module with a mesh communication, but is not limited in the present disclosure.

### Second Embodiment

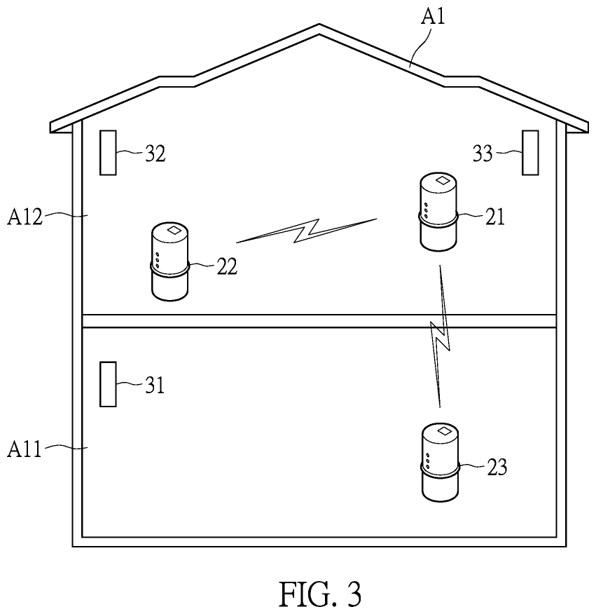

Referring to FIG. 3, FIG. 3 shows the infrared voice-controlled system being defined in a predetermined area.

In FIG. 3, the predetermined area A1 is a house having two floors. A first infrared voice-controlled device 21, a second infrared voice-controlled device 22, a second electronic device 32, and a third electronic device 33 are disposed on a second floor A12. A third infrared voice-controlled device 23 and a first electronic device 31 are disposed on a second floor A11.

In the embodiment, the first electronic device 31, the second electronic device 32, and the third electronic device 33 are controlled by the infrared control signals. Since the infrared control signals cannot be transmitted between the first floor A11 and the second floor A12, different infrared voice-controlled devices are disposed on the first floor A11 and the second floor A12.

The first infrared voice-controlled device 21, the second infrared voice-controlled device 22, and the third infrared voice-controlled device 23 communicate with each other by the second communication modules (not shown) of first infrared voice-controlled device 21, the second infrared voice-controlled device 22, and the third Infrared voice-controlled device 23. In other words, the second electronic device 32 and the third electronic device 33 on the second floor can be controlled when the user sends an audio control signal to the third infrared voice-controlled device 23. When the user sends the audio control signal to the third infrared voice-controlled device 23, the second communication module (not shown) of the third infrared voice-controlled device 23 communicates with the second communication module (not shown) of the first infrared voice-controlled device 21, and the audio control signal is transmitted, accordingly. Then, the first infrared voice-controlled device 21 transmits the infrared control signal of the third electronic device 33 for controlling the third electronic device 33.

In conclusion, the infrared voice-controlled system and the infrared voice-controlled device directly utilize the infrared signal transmitting module of the infrared voice-controlled device to control the electronic device. It is not necessary to use another control device to transmit the control signal, so as to reduce equipment costs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated.

Alternative embodiments will become apparent to those skilled in the art to which the present disclosure pertains without departing from its spirit and scope.

What is claimed is:

1. An infrared voice-controlled system comprising:
an infrared voice-controlled device connected to a first electronic device;
a service server, the infrared voice-controlled device being connected to the service server; and
an infrared signal database, the service server being connected to the infrared signal database;
wherein when the infrared voice-controlled device receives an audio control signal corresponding to the first electronic device, the infrared voice-controlled device transmits the audio control signal to the service server, the service server transmits a device control signal corresponding to the audio control signal and the first electronic device to the infrared voice-controlled device, and the infrared voice-controlled device controls the first electronic device based on the device control signal;
wherein the device control signal includes a first infrared communication protocol, and the first infrared communication protocol is stored in the infrared signal database.

2. The infrared voice-controlled system of claim 1, wherein the infrared voice-controlled device includes a processing module, an infrared signal transmitting module, and an infrared signal receiving module, the processing module is electrically connected to the infrared signal transmitting module and the infrared signal receiving module, and the processing module transmits a first infrared control signal through the infrared signal transmitting module.

3. The infrared voice-controlled system of claim 1, wherein the infrared voice-controlled device further includes a first communication module and a second communication module, the processing module is electrically connected to the first communication module and the second communication module, the infrared voice-controlled device communicates with the service server by the first communication module, the infrared voice-controlled device communicates with another infrared voice-controlled device by the second communication module, and the second communication module is a Bluetooth™ 5.0 communication module or a Bluetooth™ 5.1 communication module.

4. An infrared voice-controlled device comprising:
a processing module;
a microphone module receiving an audio control signal;
an infrared signal transmitting module transmitting an infrared control signal;
an infrared signal receiving module receiving an infrared control signal;
a first communication module used for being connected to a server; and
a second communication module, the processing module being electrically connected to the microphone module, the infrared signal receiving module, the infrared signal transmitting module, the first communication module, and the second communication module;
wherein when microphone module of the infrared voice-controlled device receives an audio control signal corresponding to the first electronic device, the processing module transmits the audio control signal to the service server, the service server transmits a device control signal corresponding to the audio control signal and the first electronic device to the infrared voice-controlled device, the infrared voice-controlled device controls the first electronic device based on the device control signal, and the infrared signal transmitting module transmits a first infrared control signal to control the first electronic based on the device control signal.

5. The infrared voice-controlled device of claim 4, wherein the infrared signal transmitting module is arranged at an exterior of the infrared voice-controlled device in a ring-shaped manner.
